(19) United States
(12) Patent Application Publication
(10) Pub. No.: US 2024/0143306 A1
(43) Pub. Date: May 2, 2024

(54) METHOD AND APPARATUS TO INCENTIVIZE A USER TO UPDATE A DEVICE

(71) Applicant: MOTOROLA SOLUTIONS, INC., Chicago, IL (US)

(72) Inventors: JONATHAN CHAN, Bukit Mertajam (MY); LOGESVARY POO GOPALASAMY, Sungai Petani (MY); BENG KWANG TAN, Bayan Lepas (MY); SHINN WOEI OOI, Georgetown (MY); REXY PRAKASH CHACKO, Gelugor (MY); Anoop Sehgal PARAS RAM, Ipoh (MY); Uvarajan Moorthy, Bedong (MY); Yei Lan Lee, Permatang Pauh (MY); NOR SABRINA Abu ZAKI, Bayan Lepas (MY)

(21) Appl. No.: 18/051,040

(22) Filed: Oct. 31, 2022

(51) Int. Cl. G06F 8/65; H04L 67/00

(52) U.S. Cl. CPC G06F 8/65; H04L 67/34

(57) ABSTRACT

A method and apparatus for incentivizing a user to update a device is provided herein. During operation, an update manager will determine a past history of performance problems specific to the device that needs updating. The device manager will also determine problems fixed with the update. A personalized message that mentions the past history of performance problems that are fixed with the update will be provided to the user along with a request to update the device.

### BACKGROUND OF THE INVENTION

Part of a device ownership experience for many users includes the need to regularly update the device. Oftentimes users of these devices are reluctant to update their device because of the time it takes to perform the update. In some cases, the update may be deferred for years. It would be beneficial if users can be incentivized to update their devices so that any delay in updating their devices is reduced.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a general operating environment where devices are updated.

FIG. 2 illustrates incentivizing users to update by sending them personalized messages.

FIG. 3 illustrates incentivizing users to update by sending them personalized messages.

FIG. 4 illustrates incentivizing users to update by sending them personalized messages.

FIG. 5 is a block diagram of an update manager.

FIG. 6 is a block diagram of an update manager.

FIG. 7 is a flow chart showing operation of the update manager.

### DETAILED DESCRIPTION

In order to address the above-mentioned need, a method and apparatus for incentivizing a user to update a device is provided herein. During operation, an update manager will determine a past history of performance problems specific to the device that needs updating. The device manager will also determine problems fixed with the update. A personalized message that mentions the past history of performance problems that are fixed with the update will be provided to the user along with a request to update the device.

As an example of the above, assume that a user's device keeps shutting down unexpectedly. If an update to the device is available that addresses this problem, a personalized message may be sent to the device indicating that the update will solve the problem of their device unexpectedly shutting down.

By personalizing an update message (i.e., a personalized message sent to the user requesting them to update their device, the message comprising a description of a past problem experienced), the user will be provided with information on how the update will specifically fix problems that they have experienced with the device. This will incentivize the user to perform the update.

The past history of performance problems for a device may be determined by examining past tickets created by the customer on the device, past problems reported by the customer on the device, past calls to a help center regarding the device, past problems that were self-reported by the device (e.g., either via log analytics or black-box mechanisms), past internet searches that attempted to find solutions to a particular problem with the device, past interactions with any “troubleshooting” application on the device . . . , etc. Some of these are described in more detail below.

Past tickets created and problems reported by the customer on the affected device—Typically, centralized help is provided to users within an enterprise. Such centralized help is referred to as a help center, computer support center, help desk, IT response center, customer support center, IT solutions center, resource center, information center, technical support center, among other things. During a call to the help center, users typically report problems with a device and the help-center staff often creates a ticket that tracks customer support/progress with respect to the reported problem. The ticket will describe a problem with the device experienced by the user. Even when a ticket is not created, oftentimes the call and the problem are logged into a database.

Past problems that were self-reported by the device—Oftentimes device health status is provided automatically by the device to a centralized location monitored by makers of the device. This allows for major problems experienced by the device to be tracked and identified quickly. Oftentimes even the most minor problems experienced by the device, (e.g., low-battery alarm) are provided to the centralized location and logged/stored associated with the device.

Past internet searches—Oftentimes an owner of a device will attempted to find solutions to a particular problem experienced with the device by performing an internet search on the particular problem. These internet searches are oftentimes stored locally or in the cloud as a “search history”. If an update addresses particular problems with a device, the search history of the user may be searched to determine if the user attempted to solve any of the problems that are corrected with the update.

Past interactions with any “troubleshooting” application on the device—Oftentimes devices are provided with a troubleshooting application that comprises a software application used for solving a problem with the device. The software comprises steps for a logical, systematic search for the source of a problem in order to solve it, and make the product or process operational again. A troubleshooting application is provided with particular problems the device is experiencing. These problems are typically provided by a user of the device, and may be logged or stored on the device or in the cloud. If an update addresses particular problems with a device, past problems provided by the user to the troubleshooting application may be searched to determine if the user attempted to solve any of the problems that are corrected with the update.

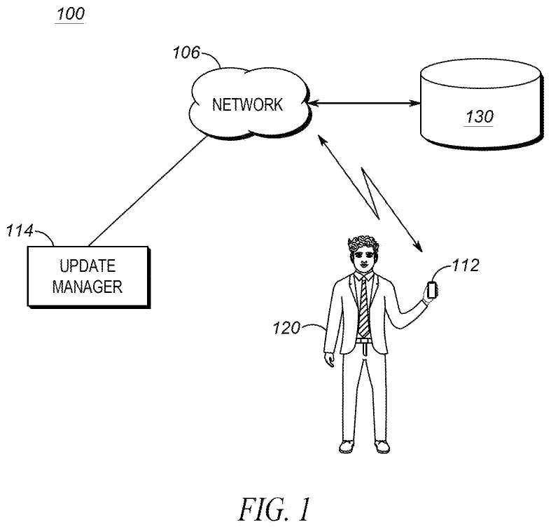

Turning now to the drawings wherein like numerals designate like components, FIG. 1 illustrates a general operating environment where devices are updated and personalized messages are provided to users. Environment 100 includes one or more networks 106, user device 112, update manager 114, and external memory 130 (i.e., memory external to update manager 114). In a preferred embodiment of the present invention, update manager 114 serves to provide updates to devices 112 as described above. In particular, update manager 114 determines when an update is available for device 112 and notifies device 112 of the available update. As discussed above, a personalized message may be provided with the notification that describes past problems that have been experienced by device 112 and notifies user 120 that the update will address or fix the past problems experienced.

With the above in mind, the past problems experienced by device 112 may be determined by update manager 114 accessing external memory 130, internal memory (not shown in FIG. 1), or memory contained within device 112 (not shown in FIG. 1). For example, memory 130 may comprise a database that exists at a helpdesk that comprises tickets and problems logged for device 112. Additionally, memory 130 may comprise a database that contains problems that have been self reported by device 112. It should be noted that although only one external memory 130 is shown in FIG. 1, there may exist many databases 130, all providing update manager 114 with past problems experienced by device 112. These databases may exist within help centers, call centers, the cloud, or any type of support center. They may also exist in databases maintained for device self reporting of problems experienced by devices.

In one embodiment of the present invention, update manager 114 utilizes network 106 for communication between update manager 114 and database 130. Network 106 preferably comprises a cellular communication system or a radio-access network. Such networks include, but are not limited to a radio core network (which may be a private network), and a public network (e.g., Verizon, Spring, AT&T, . . . , etc.). Network 106 may include typical network elements such as base stations, base station controllers (BSCs), routers, switches, and the like, arranged, connected, and programmed to provide wireless service to device 112 (e.g., a radio or smart phone operated by user 120) in a manner known to those of skill in the relevant art.

Although only one user device 112 is shown in FIG. 1, environment 100 typically comprises many devices 112 (e.g., hundreds or thousands). Device 112 may be any suitable computing and communication devices configured to engage in wireless communication over an air interface as is known to those in the relevant art. User device 112 may comprise any device capable of being updated and providing a message to user 120. For example, user devices 112 may comprise a mobile device running an Android™ or iOS™ operating system, or may be a computer, or a laptop computer capable of displaying messages sent to it from update manager 114.

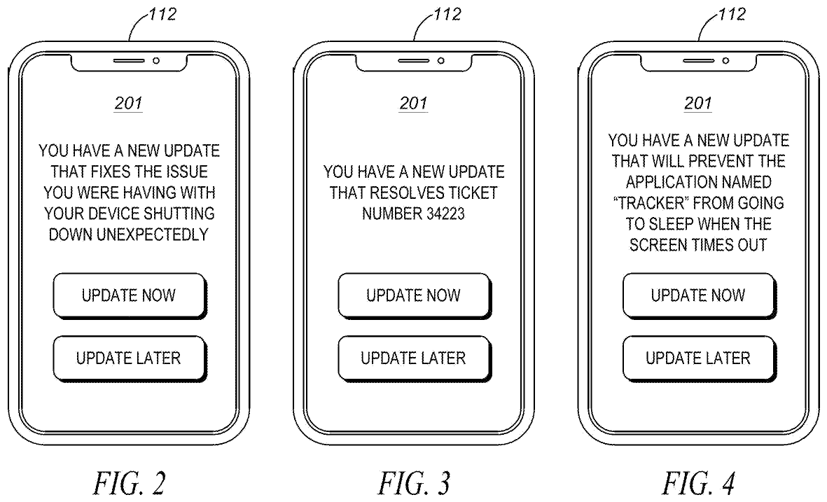

During operation, update manager 114 receives software that is to be provided to devices 112 as part of an update. Update manager 114 determines problems fixed with the update. This is preferably accomplished by receiving this information from a user via a graphical-user interface (not shown in FIG. 1). Update manager 114 then determines problems that have been encountered by each device 112. If any particular device 112 has experienced any of the problems that are fixed with the software update, update manager 114 will send a notification to device 112 that a software update is available that fixes the particular past problems experienced by device 112 that are fixed. This is illustrated in FIG. 2 through FIG. 4.

As shown in FIG. 2, update manager 114 has determined that device 112 has been having problems with the device shutting down unexpectedly. When an update is available that fixes this problem, a message is sent to device 112 that mentions the problem. Device 112 comprises graphical-user interface 201 (such as a computer screen or touch screen on a smart phone) that displays the message. In this case, “You have a new update that fixes the problem you were having with your device shutting down unexpectedly.” Two soft keys are shown that allow the user to update now or later.

As shown in FIG. 3, update manager 114 has determined that device 112 has been having problems that were reported in ticket number 34223. When an update is available that fixes the problems reported in the ticket, a message is sent to device 112 that mentions the ticket. Device 112 then displays the message. In this case, “You have a new update that resolves ticket number 34223”. Two soft keys are shown that allow the user to update now or later.

As shown in FIG. 4, update manager 114 has determined a user of device 112 has performed a past internet search on how to keep an application named “tracker” from going to sleep when the touch screen times out. When an update is available that fixes this problem, a message is sent to device 112 that mentions the past internet search. Device 112 then displays the message. In this case, “You have a new update that will prevent the application named “Tracker” from going to sleep when the screen times out”. Two soft keys are shown that allow the user to update now or later.

It should be noted that if update manager 114 does not find any past problems with a particular device 112 that are fixed with a particular update, then update manager 114 will simply provide a generic message to the device 112 that an update is available, without mentioning specific problems experienced by device 112. A generic message such as, “an update is available for your device” may be sent by update manager 114 and displayed on GUI 201. The non-personalized message may also be based on the standard release note or most used features of the device.

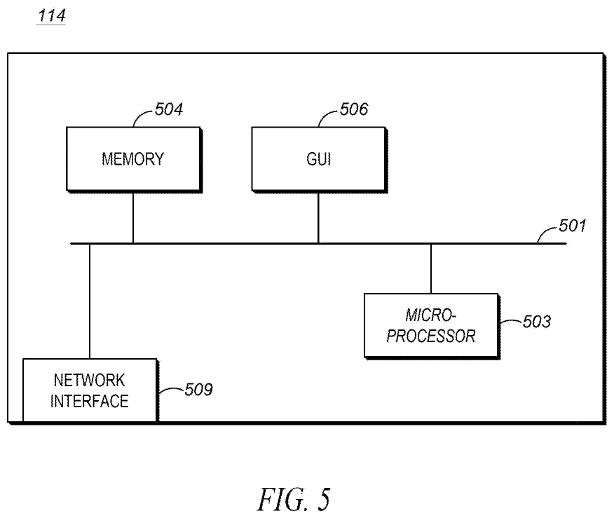

FIG. 5 is a block diagram of update manager 114. Update manager 114 may include various components connected by bus 501. Such components include, but are not limited to logic circuitry 503, memory 504, graphical user interface 506, and network interface 509. Hardware processor/microprocessor (logic circuitry) 503 comprises one or more central processing units (CPUs) or other processing circuitry able to provide any of the functionality described herein when running instructions. Logic circuitry 503 may be connected to memory 504 that may include a non-transitory machine-readable medium on which is stored one or more sets of instructions. The instructions stored in memory 504 may enable update manager 114 to operate in any manner thus programmed, such as the functionality described specifically herein, when logic circuitry 503 executes the instructions. The machine-readable medium 504 may be stored as a single medium or in multiple media, in a centralized or distributed manner, or in the cloud. In some embodiments, instructions may further be transmitted or received over a communications network via a network interface (not shown) utilizing any one of a number of transfer protocols (e.g., frame relay, internet protocol (IP), transmission control protocol (TCP), user datagram protocol (UDP), hypertext transfer protocol (HTTP), etc.).

In addition to instructions for operation, memory 504 is also configured to store past device problems. As described above, these past device problems are problems that have actually been experienced by the device, and are used to create a private message communicated to the device when requesting the device to perform an update.

Graphical-user interface 506 provides a man/machine interface for receiving an input from a user and displaying information. Part of the input from the user may comprise information on problems fixed by an update. More particularly, when an update is available for devices, an operator at the update center may provide memory 504 and/or logic circuitry 503 with a list of performance problems fixed by the update. In order to provide the above features (and additional features), GUI 506 may comprise any combination of a touch screen, a computer screen, a keyboard, or any other interface needed to receive a user input.

Network interface 509 is provided, and comprises elements including processing, modulating, and transceiver elements that are operable in accordance with any one or more standard or proprietary wired or wireless interfaces, wherein some of the functionality of the processing, modulating, and transceiver elements may be performed by means of the logic circuitry 503 through programmed logic such as software applications or firmware stored on the storage component 504 or through hardware. Examples of network interfaces (wired or wireless) include Ethernet, Ti, USB interfaces, IEEE 802.11, 5 g, etc. Network interface 509 is utilized by logic circuitry 503 to communicate with any devices 112 via network 106 in order to provide devices 112 with a personalized message regarding an update to any software (application) residing on device 112 or operating systems residing on device 112. Network interface 509 is also utilized to communicate with external databases 130 in order to determine past problems experienced by devices that may exist in these external databases.

During operation memory 504 is populated with updated software to be provided to at least one device. Memory 504 may also include a list of device IDs along with past problems experienced by each device. The past problems experience by each device may be populated manually through GUI 506, or may be populated automatically via any of the self-reporting techniques, troubleshooting techniques, black box analytics, . . . , etc. Finally, memory 504 is populated with a list of problems fixed with the updated software.

During the update process, logic circuitry 503 accesses memory 504 to determine a list of devices to be updated (e.g., identification information for each device to be updated). Along with the devices to be updated, a list of past problems experienced by each device is determined from memory 504 and memory 130. A list of problems fixed with the update is then obtained from memory 504, and logic circuitry 503 then determines for each device to be updated: 1. Past problems reported for the device, 2. Problems fixed with the update; and a personalized message telling the user of the device that the update will fix the specific problems experienced by the device, specifically mentioning the problems reported, and/or a ticket number where the problems were addressed.

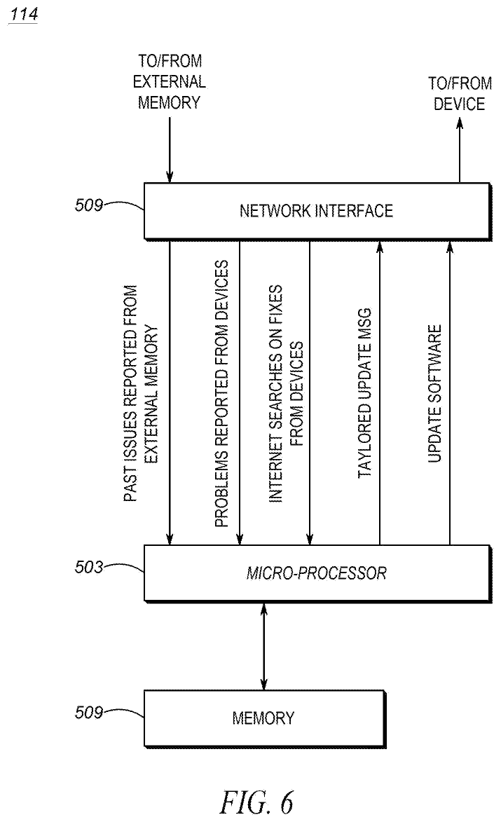

FIG. 6 is a block diagram of an update manager showing information received by logic circuitry 503 and provided by logic circuitry 503. As shown in FIG. 6, logic circuitry receives from network interface 509, past problems experienced by devices and stored in external databases 130, past problems reported by devices (e.g., via device analytics), and past internet searches on fixes for various problems experienced by the device. This information may be stored in internal memory 504. Other information on past problems experienced by devices may be received that are not shown in FIG. 6. For each device to be updated, logic circuitry 503 accesses memory 504 to determine problems that are fixed with the software update and compares them to past problems actually experienced by the device. If any of the problems to be fixed match the problems actually experienced, a personalized message is then sent to the device requesting the user of the device to update the software. The updated software may then be provided. For example, assume a software update fixed issues like unexpectedly shutting down, bad audio, and the device running hot. Assume that the device to be updated actually experienced bad audio. Then a personalized message will be sent to the device mentioning that the software update fixes the problem of bad audio. The personalize message may not include any reference to fixing unexpected shutdown or the device running hot since these problems have not been actually experienced by the device (or at least not reported as experienced by the device).

It should be noted that messages sent to each device 112 within environment 100 are specifically tailored to each device based on past problems actually experienced and reported by each device or the device's user. The messages are not based on assumed problems. For example, if a software update fixes an issue with a device unexpectedly shutting down, it may only be assumed that a device is experiencing that issue, but not guaranteed that it is experiencing that issue. Messages are not based on assumed experiences, but instead based on actual experiences that the device, or the device's owner/user has experienced.

With the above in mind, update manager 114 comprises an apparatus comprising a network interface; and logic circuitry configured to determine a past problem actually experienced by a device, determine problems fixed for the device by installing a software update, and utilize the network interface to transmit a personalized message to the device, wherein the personalized message indicates that a software update will fix the past problem actually experienced by the device.

As discussed above, the past problems actually experienced by the device comprises a problem that was reported to a helpdesk, a problem that was self reported by the device, a problem was determined via analyzing past internet searches for a user, or a problem that was reported by a troubleshooting application residing on the device, any other problem reported by the device or the user of the device.

As discussed above, sometimes multiple problems are fixed with a software update. In a preferred embodiment of the present invention, only the problems that are fixed that have actually been experienced (exhibited) by the device will be mentioned in a personalized message. Thus update manager 114 will comprise at least one database configured to store a past problem actually experienced by a device along with a first, a second, and a third problem fixed with a software update, and logic circuitry configured to access the database to determine the past problem actually experienced by a device, access the database to determine the first, second, and third problem fixed with the software update, determine that the past problem actually experienced by the device is the same problem as the first problem fixed with the software update, and utilize the network interface to transmit a personalized message to the device, wherein the personalized message indicates that a software update will fix the first problem, without mentioning the second or third problem.

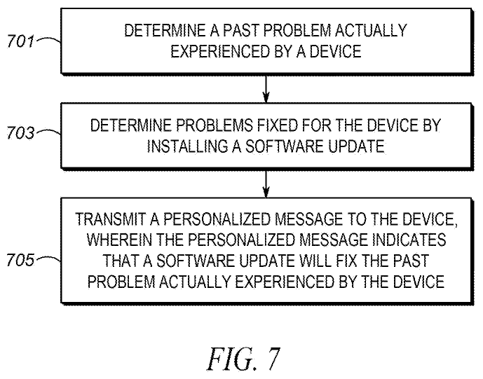

FIG. 7 is a flow chart showing operation of the update manager. The logic flow begins at step 701 where logic circuitry 503 determines a past problem actually experienced by a device. At step 703, logic circuitry 503 determines problems fixed for the device by installing a software update. Finally, at step 705, logic circuitry 503 transmits a personalized message to the device, wherein the personalized message indicates that a software update will fix the past problem actually experienced by the device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as problems.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An apparatus comprising:
a network interface;
logic circuitry configured to:
determine a past problem actually experienced by a device;
determine problems fixed for the device by installing a software update; and
utilize the network interface to transmit a personalized message to the device, wherein the personalized message indicates that a software update will fix the past problem actually experienced by the device.

2. The apparatus of claim 1 wherein the past problems actually experienced by the device comprises a problem that was reported to a helpdesk.

3. The apparatus of claim 1 wherein the past problems actually experienced by the device comprises a problem that was self reported by the device.

4. The apparatus of claim 1 wherein the past problems actually experienced by the device comprises a problem was determined via analyzing past internet searches for a user.

5. The apparatus of claim 1 wherein the past problems actually experienced by the device comprises a problem that was reported by a troubleshooting application residing on the device.

6. An apparatus comprising:
at least one database configured to store a past problem actually experienced by a device along with a first, a second, and a third problem fixed with a software update;
a network interface; and
logic circuitry configured to:
access the database to determine the past problem actually experienced by a device;
access the database to determine the first, second, and third problem fixed with the software update;
determine that the past problem actually experienced by the device is the same problem as the first problem fixed with the software update; and
utilize the network interface to transmit a personalized message to the device, wherein the personalized message indicates that a software update will fix the first problem, without mentioning the second or third problem.

7. A method comprising the steps of:
determining a past problem actually experienced by a device;
determining problems fixed for the device by installing a software update; and
transmitting a personalized message to the device, wherein the personalized message indicates that a software update will fix the past problem actually experienced by the device.

8. The method of claim 7 wherein the past problems actually experienced by the device comprises a problem that was reported to a helpdesk.

9. The method of claim 7 wherein the past problems actually experienced by the device comprises a problem that was self reported by the device.

10. The method of claim 7 wherein the past problems actually experienced by the device comprises a problem was determined via analyzing past internet searches for a user.

11. The method of claim 7 wherein the past problems actually experienced by the device comprises a problem that was reported by a troubleshooting application residing on the device.
